(19) United States
(12) Patent Application Publication
(10) Pub. No.: US 2013/0221655 A1
(43) Pub. Date: Aug. 29, 2013

(54) SECURITY PAPER THAT IS DETECTABLE BY METAL DETECTORS

(71) Applicant: Samsung Electronics Co., Ltd., (US)

(72) Inventors: Taek-yong JUNG, Suwon-si (KR); Chang-woo Jung, Seoul (KR); Ae-kyung Choi, Suwon-si (KR)

(73) Assignee: Samsung Electronics Co., Ltd., Suwon-si (KR)

(21) Appl. No.: 13/778,329

(22) Filed: Feb. 27, 2013

(30) Foreign Application Priority Data
Feb. 28, 2012 (KR) 10-2012-0020399

(51) Int. Cl. B42D 15/00

(52) U.S. Cl. CPC B42D 15/00
USPC 283/83; 427/383.1; 524/262; 524/264

(57) ABSTRACT

A security paper includes a detectable layer including metal powder, an organosilane, and a water-soluble binder resin. The security paper has high brightness. Accordingly, an image printed on the security paper has excellent qualities. Also, the security paper has a low volatile organic compound (VOC) content.

### CROSS-REFERENCE TO RELATED APPLICATIONS

This application claims the priority benefit of Korean Patent Application No. 10-2012-0020399, filed on Feb. 28, 2012, in the Korean Intellectual Property Office, the disclosure of which is incorporated herein in its entirety by reference.

### BACKGROUND 1. Field

Embodiments relate to a security paper, and in particular, to a security paper that is detectable by a metal detector.

2. Description of the Related Art

The increased significance in preventing leakage of information has lead to the development of security technologies for blocking the leakage of various data recording media. However, in the case of a recording media, such as paper, it is difficult to control transferring of the recording media. Accordingly, research into security paper that enables the transferring of paper to be blocked is performed in various fields.

To effectively manage documents, printer manufacturers have been providing a program for managing printing situations together with a printer, since the 1990s. Also, recently, many businesses have adopted management of printing system (MPS). Furthermore, printer manufacturers and printer users consider using security paper together with MPS.

As a method of manufacturing security paper, various methods, for example, a method of manufacturing security paper using a hidden line, a method of manufacturing security paper using a fluorescent material, or a method of manufacturing security paper using a metallic tag, are known. Also, for use of metal detectors which are widely used in a security system, manufacturing of security paper that is detectable by a metal detector is taken into consideration.

Metal detectors are used to detect the presence of a metallic material even when the metallic material is not in sight, by using electromagnetic induction and Eddy current. When a magnetic field occurs in a coil in which an alternative current flows, Eddy current occurs in a metal due to the magnetic field. The Eddy current that occurs in the metal causes a magnetic field, which is detected by metal detectors to confirm presence of the metal. As well known, metal detectors are used for various purposes, such as removing of mines, detecting of arms at airport security check points, archaeological digging, treasure hunting, geological prospecting, or detecting of foreign materials in food.

Various papers having a stack structure including a metal layer have been disclosed. For example, KR 10-2008-0107977 (published on Dec. 11, 2008) discloses a printing paper for security purposes, including first and second paper sheets having surfaces attached to each other by using an adhesive material; and at least one detection tag interposed between the attached surfaces of the first and second paper sheets. Also, according to the disclosure of the above-described reference, the detection tag may include an amorphous soft alloy, a metal thin film may be further formed between the attached surfaces of the first and second paper sheets, and the first paper sheet or the second paper sheet may have a surface on which metal may be vacuum-deposited or transferred.

However, laminating of many layers may cause many problems: for example, manufacturing costs may be increased; curling of paper may occur during the laminating process; and excess volatile organic compounds (VOC) may be included in paper due to an adhesive used during the laminating process.

VOC contained in paper may be released by heating during printing. The amount of VOC released during printing is restricted according to an international standard due to environmental issues. Accordingly, if VOC is released in great amounts from paper, it would be disadvantageous. In particular, when a laser printer is used, a temperature during a fixing process is, for example, from about 120° C. to about 200° C. Accordingly, the amount of released VOC may be very great.

As disclosed in Korean Patent No. 10-2008-0107977, when a metal tag is used, a black ink layer for shielding a tag may be additionally needed. When a paper sheet contains a black ink layer, paper brightness may be lowered. Brightness is one of the important factors when a quality of paper is taken into consideration. When the paper brightness is lowered, a quality of an image printed on paper is lowered.

### SUMMARY

According to an aspect of one or more embodiments, there is provided a security paper that has high brightness and a low volatile organic compounds (VOC) content and that is detectable by a metal detector.

According to an aspect of one or more embodiments, there is provided a security paper which includes a substrate sheet; and a detectable layer that is attached to at least a portion of at least a surface of the substrate sheet, wherein the detectable layer comprises metal powder, an organosilicon compound, and a water-soluble binder resin.

The security paper may further include an under-coating layer interposed between the substrate and the detectable layer.

According to an aspect of one or more embodiments, there is provided a composition for forming a detectable layer includes: metal powder, an organosilicon compound, a water-soluble binder resin, and water.

According to an aspect of one or more embodiments, there is provided a method of producing a security paper includes: coating the composition on at least a portion of at least a surface of a substrate; and drying the coated composition.

The method may further include, prior to the coating of the composition, forming an under-coating layer on the substrate.

### DETAILED DESCRIPTION

Embodiments will now be described more fully with reference to the accompanying drawings, in which exemplary embodiments are shown. Expressions such as “at least one of,” when preceding a list of elements, modify the entire list of elements and do not modify the individual elements of the list.

A security paper according to an embodiment t includes a substrate sheet, and a detectable layer that is attached to at least a portion of at least a surface of the substrate, wherein the detectable layer includes metal powder, an organosilane, and a water-soluble binder resin.

The substrate may be, for example, paper or a resin film. The paper may be, for example, a paper that is coated with a resin or a paper that is not coated with a resin. The paper that is not coated with a resin may be, for example, wood-free paper or thin paper. The paper that is coated with a resin may be, for example, art paper or coated paper, cast coated paper, or resin coated paper. The resin film may be, for example, polyethylenetelephthalate, polycarbonate, or cellulose acetate. A thickness of the substrate may not be particularly limited.

The detectable layer may be attached to at least a portion of at least a surface of the substrate. The detectable layer may be coated completely on a surface of the substrate. The detectable layer may be coated on a portion of a surface of the substrate. A region for the detectable layer may be appropriately selected according to a detect-ability of the metal detector. Alternatively, to increase the detect-ability of security paper, the detectable layer may be attached to a portion of each of both surfaces of the substrate: in this case, the detectable layer may be attached to a surface of the substrate and the other surface of the substrate; or the detectable layer may be attached to a surface of the substrate and a portion of the other surface of the substrate; or the detectable layer may be attached to a portion of a surface of the substrate and the other surface of the substrate; or the detectable layer may be attached to a portion of a surface of the substrate and a portion of the other surface of the substrate. When the detectable layer is located on a portion of any one of surfaces of the substrate, the location of the detectable layer is not limited. Accordingly, the detectable layer may be located in either a printing area or a non-printing area, or both a printing area and a non-printing area.

The detectable layer may include a metal powder, an organosilane, and a binder resin.

When only metal powder is used, a detect-ability of security paper is high. However, manufacturing costs for security paper may increase, and it would be difficult to coat the detectable layer on the substrate. Accordingly, by using metal powder and an organosilane together, manufacturing costs for security paper may decrease and the detectable layer may be easily coated on the substrate. Also, formed security paper may have an excellent detect-ability.

The metal powder may be any one of metals that are detectable by a metal detector. An example of the metal powder may be iron, cobalt, nickel, manganese, silver, copper, zirconium, aluminum, or a combination thereof. For example, metal powder may be a ferromagnetic metal. An example of the ferromagnetic metal may be iron, cobalt, nickel, manganese, or a combination thereof. Due to the use of ferromagnetic metal powder, an excellent detect-ability may be obtained with a relatively small amount.

A particle size of the metal powder may not be limited. However, when the particle size of the metal powder is too small, the detect-ability may be lowered, and when the particle size of the metal powder is too great, dispersibility of the metal powder in a composition for forming the detectable layer may be lowered. For example, an average particle size of the metal powder may be in a range of about 0.1 μm to about 100 μm.

Organosilanes refer to an organic compound in which at least one carbon atom is substituted with a silicon atom. Furthermore, the meaning of organosilanes includes an inorganic compound in which all carbon atoms of an organic compound are substituted with silicon atoms. Due to the use of an organosilane, the amount of metal powder may be reduced while the detect-ability of security paper is maintained, and also, stability of a coating solution may be increased.

Examples of an organosilane are halogenosliane, alkoxysilanes, aminosilanes, silane coupling agents, fluoroalkylsilanes, reactive siloxane oligomers, or a combination thereof.

Detailed examples of halogenosliane are chlorosilane, trichlorosilane, methyldichlorosilane, and phenyldichlorosilane.

Detailed examples of alkoxysilanes are methyldiethoxysilane, methyldimethoxysilane, phenyldimethoxysilane, trimethoxysilane, and triethoxysilane.

Detailed examples of aminosilanes are methyldiaminosilane and triaminosilane.

Detailed examples of aminoxysilanes are methyldiaminoxysilane and triaminoxysilane.

Detailed examples of acyloxysilanes are methyldiacetoxysilane, phenyldiacetoxysilane, and triacetoxysilane.

The water-soluble binder resin may increase stability of metal powder and an organosilane and an adhesion force thereof with respect to the substrate. The water-soluble binder resin may be, for example, polyvinylalcohol, polyvinylpyrrolidone, cellulose, polyacryl, polyester, latex, or a combination thereof.

When the detectable layer has too low a content of the metal powder, the detect-ability may be reduced. On the other hand, when the detectable layer has too high a content of the metal powder, a detect-ability of security paper may be increased. In this case, however, cost for materials used in preparing security paper may be increased too much. For example, an amount of the metal powder in the detectable layer may be in a range of about 1 wt % to about 10 wt % based on 100 wt % of the total weight of the detectable layer.

Even when the metal powder content is about 10 wt % or less, the security paper according to an embodiment may have an excellent detect-ability. Such an effect may be due to the fact that the organosilicon compound also has a detect-ability and a coating solution thereof has an excellent dispersibility, and thus, detect-ability of the security paper is also improved.

When the amount of the organosilane in the detectable layer is too small, the manufacturing costs may be increased or dispersibility of a coating solution thereof may be reduced. When the amount of the organosilane in the detectable layer is too great, the detect-ability may be reduced. For example, the amount of the organosilane in the detectable layer may be in a range of about 1 wt % to about 50 wt % based on 100 wt % of the total weight of the detectable layer. The organosilane is relatively inexpensive compared to the metal powder. Accordingly, even when the amount of the organosilane is as high as about 50 wt % based on 100 wt % of the total weight of the detectable layer, the effects of the organosilane on the manufacturing costs for security paper may be negligible.

The amount of the water-soluble binder resin in the detectable layer may be a remainder after weights of the metal powder and the organosilane are subtracted from the total weight of the detectable layer. For example, the amount of the water-soluble binder resin in the detectable layer may be in a range of about 50 wt % to about 95 wt % based on 100 wt % of the total weight of the detectable layer. Although the amount of the water-soluble binder resin is as low as about 50 wt %, the water-soluble binder resin may sufficiently function as providing an adhesion force between the detectable layer and the substrate and fixing the metal powder and the organosilane in the detectable layer.

When the thickness of the detectable layer increases, a detect-ability of security paper may increase. However, when the detectable layer is too thick, when security paper is used in an inkjet printer, a decrease in ink adsorption force and a decrease in ink drying speed may occur, and when security paper is used in a laser printer, a decrease in fixability of toner and a decrease in transferring efficiency of toner may occur. Also, the greater thickness the detectable layer has, the higher manufacturing costs security paper has. When the detectable layer is too thin, detect-ability may decrease. For example, the thickness of the detectable layer may be in a range of about 1 μm to about 10 μm.

The detectable layer according to an embodiment may have the same level of brightness as a typical duplicating paper. Brightness of paper is a critical factor in determining a quality of an image, and when the level of brightness decrease, chroma or brightness of a printed image may decrease.

The shape and area of the detectable layer of the security paper are not particularly limited. For example, even when three detectable layers each having a bar shape having a width of 1 mm extending from an upper portion to a lower portion of security paper are formed on a surface of security paper, excellent detect-ability was obtained.

According to an embodiment of, the security paper may further include an under-coating layer between the substrate and the detectable layer. The under-coating layer may enhance an adhesion force between the substrate and the detectable layer. When the adhesion force is weak, during printing using a printer, the substrate and the detectable layer may be exfoliated from each other. The under-coating layer is useful when the substrate is a resin film. The under-coating layer is more useful when the substrate is a hydrophobic resin film.

The under-coating layer may be, for example, an adhesive layer. Alternatively, to minimize the VOC content in the security paper, the under-coating layer may be formed of a water-soluble resin. A water-soluble resin for use in the under-coating layer may be, for example, a polyol-based resin, an acryl-based resin, a poly urethane-based resin, a vinyl resin, or a combination thereof.

The under-coating layer may further include an inorganic filler. An example of the under-coating layer may be, for example, calcium carbonate, titanium dioxide, clay, talc, silica, or alumina.

When the under-coating layer is too thick, in the case of an ink-jet printer, an ink adsorption force may be reduced, and in the case of a laser printer, fixability may be lowered. When the under-coating layer is too thin, the increase in the adhesion force between the substrate and the detectable layer may be negligible. For example, a thickness of the under-coating layer may be in a range of about 0.1 to about 5 μm.

The under-coating layer may be formed to overlap where at least the detectable layer is formed, for example.

Another aspect of an embodiment provides a composition for forming a detectable layer, wherein the composition includes metal powder, an organosilane, a water-soluble binder resin, and water.

Water functions as a solvent for the water-soluble binder resin, a solvent or a dispersing medium for the organosilane, and a dispersing medium for the metal powder. Due to the use of water and the water-soluble binder resin, the VOC content in the detectable layer of the security paper may be minimized.

An amount of water in the composition may be appropriately determined in such a way that the composition retains a viscosity that is appropriate for a coating method used in coating the composition on a substrate. When the water content in the composition is too low, dispersibility or coating properties may be reduced, and when the water content in the composition is too high, the thickness of the detectable layer may not be increased. For example, the water content in the composition may be in a range of about 100 parts by weight to about 1000 parts by weight based on 100 parts by weight of all of the components that form the detectable layer. For example, a viscosity of the composition may be in a range of about 100 cP to about 5000 cP.

To effectively disperse metal powder, the composition may further include a dispersing agent. The dispersing agent may be, for example, polycarboxylate, sodium polyphosphate, or a combination thereof. An amount of the dispersing agent may be, for example, in a range of about 0.5 parts by weight to about 10 parts by weight, based on 100 parts by weight of the metal powder.

Another aspect of an embodiment provides a method of manufacturing security paper, the method including: coating the composition according to an embodiment on at least a portion of at least a surface of a substrate; and drying the coated composition.

The substrate may be used in a form of, for example, sheet or roll.

The coating may be performed by using various coating methods, for example, spraying, painting, or printing. For example, the coating may be performed by using a blade coater, a bar coater, a gravure coater, an air-knife coater, a roll-to-roll coater, or the like.

The drying may be performed by using a typical drying method, for example, natural drying, freeze drying, or hot drying.

According to an embodiment, the method may further include, prior to the coating of the composition, forming an under-coating layer on the substrate.

The forming of the under-coating layer may be performed by coating a composition for forming an under-coating layer which includes an aqueous solution of a water-soluble resin on at least a portion of at least a surface of the substrate. Drying of the coated under-coating layer forming composition may be performed together with the drying of the composition for forming the detectable layer. Alternatively, the forming of the under-coating layer may be performed by coating the under-coating layer forming composition including an aqueous solution of a water-soluble resin on at least a portion of at least a surface of the substrate, followed by drying the coated under-coating layer forming composition. The coating and drying of the under-coating layer forming composition may be performed by using the same methods as described above with reference to the composition for forming the detectable layer. A water content in the under-coating layer forming composition may be appropriately selected to obtain a viscosity that is appropriate for a selected coating method. When the water content in the under-coating layer forming composition is too low, coating properties may decrease, and when the water content in the under-coating layer forming composition is too high, drying time may be too long. For example, the water content in the under-coating layer forming composition may be in a range of about 500 parts by weight to about 10000 parts by weight based on 100 parts by weight of the water-soluble binder resin. For example, a viscosity of the under-coating layer forming composition may be in a range of about 10 cP to about 1000 cP.

### EXAMPLE

### Example 1

### Preparation of Composition for Forming Detectable Layer

18.0 parts by weight of polyvinylalcohol (a product of Korea OCI Company, 1.0 parts by weight of cobalt powder (a product of Korea Seochong Materials Company, an average particle size of 5 μm), 1.0 parts by weight of a silane coupling agent (a product of Korea Siltech Company, TSL8311), 0.1 parts by weight of dispersing agent (a product of Jungwoo Chemistry-Korea, Kosant A-40), and 80.0 parts by weight of water were mixed by using a ball mill to prepare a composition for mixing a detectable layer.

### Example 2

### Preparation of Composition for Forming Detectable Layer

15.3 parts by weight of hydroxypropylmethylcellulose (a product of Samsung Fine Chemicals—Korea, Anycoat-C), 1.0 parts by weight of cobalt powder (a product of Seochong Materials Company-Korea, an average particle size of 10 μm), 1.0 parts by weight of a silane coupling agent (a product of Siltech Company-Korea, TSL8380), 0.1 parts by weight of dispersing agent (a product of Jungwoo Chemistry-Korea, Kosant TT-400), and 80.0 parts by weight of water were mixed by using a ball mill to prepare a composition for mixing a detectable layer.

### Example 3

### Preparation of Composition for Forming Detectable Layer

18.0 parts by weight of polyvinylalcohol (a product of OCI Company-Korea, 1.0 parts by weight of zirconium powder (a product of Seochong Materials Company-Korea, an average particle size of 5 μm), 1.0 parts by weight of an alkoxysilane (a product of Siltech Company-Korea, TSL8124), 0.1 parts by weight of dispersing agent (a product of JungwooChemistry-Korea, Kosant TT-400), and 80.0 parts by weight of water were mixed by using a ball mill to prepare a composition for mixing a detectable layer.

### Example 4

### Preparation of Security Paper

The composition prepared according to Example 1 was coated completely on the surface of a sheet of wood-free paper having a size 80 g/m² manufactured by Hansol Paper Company by using a bar coater. The coated sheet was dried at a temperature of 100° C. for 1 minute. A weight of the prepared security paper was 90 g/m², and a weight and a thickness of the formed detectable layer were 10 g/m² and 10 um, respectively.

### Example 5

### Preparation of Security Paper

The composition prepared according to Example 3 was coated completely on the surface of a sheet of wood-free paper having a size 80 g/m² manufactured by Hansol Paper Company by using a bar coater. The coated sheet was dried at a temperature of 100° C. for 1 minute. A weight of the prepared security paper was 90 g/m², and a weight and a thickness of the formed detectable layer were 10 g/m² and 10 μm, respectively.

### Example 6

### Preparation of Security Paper

The composition prepared according to Example 3 was coated completely on the surface of a sheet of wood-free paper having a size 80 g/m² manufactured by Hansol Paper Company by using a bar coater. The coated sheet was dried at a temperature of 100° C. for 1 minute. A weight of the prepared security paper was 90 g/m², and a weight and a thickness of the formed detectable layer were 10 g/m² and 10 μm, respectively.

### Example 7

### Preparation of Security Paper

The composition prepared according to Example 1 was coated completely on the surface of a sheet of wood-free paper having a size 80 g/m² manufactured by Hansol Paper Company by using a bar coater. The coated sheet was dried at a temperature of 100° C. for 1 minute. A weight of the prepared security paper was 85 g/m², and a weight and a thickness of the formed detectable layer were 5 g/m² and 5 μm, respectively.

### Example 8

### Preparation of Security Paper

Security paper was prepared in the same manner as in Example 4, except that 107 μm PET(SH62) manufactured by SKC Company was used as a substrate. A thickness of a formed detectable layer of the security paper was 10 μm.

### Comparative Example 1

### Preparation of Security Paper

Security paper was prepared in the same manner as in Example 4, except that a weight of a formed detectable layer was 0.5 g/m² after drying. A thickness of the detectable layer of the security paper was 0.5 μm.

### Comparative Example 2

### Preparation of Security Paper

Security paper was prepared in the same manner as in Example 4, except that a weight of a formed detectable layer was 12 g/m² after drying. A thickness of the detectable layer of the security paper was 12 μm.

### Comparative Example 3

### Preparation of Commercially Available Security Paper

Security paper (10-2008-0108063, 10-2008-0107977) manufactured by Koreit Company, including a cobalt-based metal chip disposed between two sheets of paper, was purchased.

### <Evaluation Results>

Brightness, optical density of printed images, ink adsorption force, toner fixability, a TVOC release amount during printing, and a metal detector detect-ability of the security papers manufactured according to Examples 4 to 8 and Comparative Examples 1 to 3 were evaluated.
Brightness: brightness of security paper was measured 10 times by using a colorimeter (USA “McBeth” Company “SpectroEye”) and an average thereof was used. The higher brightness, the better.
Optical density of printed images: a yellow block image was printed on security paper by using a CLP-315 printer manufactured by Samsung Electronics Co., Ltd -Korea, and then an optical density of a yellow block image was measured by using a colorimeter (USA “McBeth” Company “SpectroEye”). The higher value, the more the distinctive image.
Ink adsorption force: a black block image was printed on security paper by using Japan EPSON Company stylus 915 inkjet printer. 30 seconds after the printing, the black block image was scrubbed three times by using a pendulum having a weight of 100 g, and then, a bleeding level of the black block image was measured based on a 5-point method. The lower the bleeding level, the greater the ink adsorption force.
Toner fixability: a black block image was printed on security paper by using a CLP-315 color laser printer manufactured by Samsung Electronics Co., Ltd -Korea, and then, first optical density was measured by using SpectroEye measuring device of USA McBeth Company. 60 seconds after, a 30M tape was attached to a black block image, and then a pendulum having a weight of 500 g was scrubbed thereon ten times, and the, the tape was removed and a second optical density of the black block image was measured. A ratio of the first optical density to the second optical density is a residual rate. The higher the residual rate, the higher toner the fixability.
TVOC release amount during printing: The TVOC release amount was measured according to a guideline “Blue Angel” presented by a German material test research center (BAM) (printer: a mono laser printer SCX-6545N manufactured by Samsung Electronics Co., Ltd-Korea, a test method : RAL-UZ 122).
Metal detector detect-ability: whether security paper was detectable by a metal detector (USA Dokscom Company AD-2600S) was confirmed. The test results were evaluated as “detection” or “non-detection.” A distance between the metal detector and the security paper was 5 cm.

Evaluation results obtained by using the security papers of Examples 4 to 8 and Comparative Examples 1 to 3 are shown in Table 1.

TABLE 1

| | | Printed | | | | |
|---|---|---|---|---|---|---|
| | | image | Ink | Toner | | |
| | | optical | absorption | fixability | TVOC | |
| | Brightness (%) | density | force | (%) | (mg/h) | Detectability |
| Example 4 | 90 | 1.25 | 1 | 95 | 9 | Detection |
| Example 5 | 88 | 1.21 | 1 | 93 | 8 | Detection |
| Example 6 | 90 | 1.23 | 1 | 94 | 10 | Detection |
| Example 7 | 91 | 1.27 | 1 | 95 | 8 | Detection |
| Example 8 | 90 | 1.23 | 2 | 88 | 10 | Detection |
| Comparative | 90 | 1.23 | 1 | 92 | 7 | Non- |
| Example 1 | | | | | | detection |
| Comparative | 89 | 1.22 | 3 | 80 | 10 | Detection |
| Example 2 | | | | | | |
| Comparative | 80 | 1.05 | 1 | 85 | 21 | Detection |
| Example 3 | | | | | | |

The security paper of Examples 4 to 8 had a brightness of 88% to 91% and the security paper of Comparative Example 3 had a brightness of 80%. That is, the security paper of Examples 4 to 8 had a brightness 10% greater than that of the security paper of Comparative Example 3.

Images printed on the security paper of Examples 4 to 8 had an optical density of 1.21 to 1.27, and an image printed on the security paper of Comparative Example 3 had an optical density of 1.05. That is, images printed on the security paper of Examples 4 to 8 had an optical density 15% greater than that of an image printed on the security paper of Comparative Example 3.

The security paper of Examples 4 to 7 had a toner fixability of 93% to 95% and the security paper of Comparative Example 3 had a toner fixability of 85%. That is, the security paper of Examples 4 to 7 had a toner fixability 9% greater than that of the security paper of Comparative Example 3.

The security paper of Examples 4 to 78 had a TVOC release amount of 8 to 10 mg/h and the security paper of Comparative Example 3 had a TVOC release amount of 21 mg/h. That is, the security paper of Examples 4 to 8 had a TVOC release amount 52% greater than that of the security paper of Comparative Example 3.

As described above, the security paper of Examples 4 to 8 has excellent detect-ability with respect to a metal detector as well as excellent qualities as printing paper security paper.

A security paper according to an embodiment is detectable by a metal detector. The security paper has high brightness. Accordingly, an image printed on the security paper has excellent qualities. Also, the security paper has a low volatile organic compound (VOC) content.

While exemplary embodiments have been shown and described, it will be understood by those of ordinary skill in the art that various changes in form and details may be made therein without departing from the spirit and scope of the present disclosure as defined by the following claims.

1. A security paper comprising:
a substrate; and
a detectable layer that is attached to at least a portion of at least a surface of the substrate,
wherein the detectable layer comprises metal powder, an organosilicon compound, and a water-soluble binder resin.

2. The security paper of claim 1, wherein the substrate is a paper that is coated with a resin, a paper that is not coated with a resin, or a resin film.

3. The security paper of claim 1, wherein the metal powder of the detectable layer is a ferromagnetic metal, wherein the ferromagnetic metal is iron, cobalt, nickel, manganese, or a combination thereof.

4. The security paper of claim 1, wherein an average particle size of the metal powder is in a range of about 0.1 μm to about 100 μm.

5. The security paper of claim 1, wherein the organosilicon compound of the detectable layer is halogenosliane, alkoxysilanes, aminosilanes, silane coupling agents, fluoroalkylsilanes, reactive siloxane oligomers, or a combination thereof.

6. The security paper of claim 1, wherein the water-soluble binder resin of the detectable layer is polyvinylalcohol, polyvinylpyrrolidone, cellulose, polyacryl, polyester, a derivative thereof, latex, or a combination thereof.

7. The security paper of claim 1, wherein an amount of the metal powder in the detectable layer is in a range of about 1 wt % to about 10 wt % based on 100 wt % of the total weight of the detectable layer.

8. The security paper of claim 1, wherein an amount of the organosilicon compound in the detectable layer is in a range of about 1 wt % to about 50 wt % based on 100 wt % of the total weight of the detectable layer.

9. The security paper of claim 1, wherein a thickness of the detectable layer is in a range of about 1 μm to about 10 μm.

10. The security paper of claim 1, further comprising an under-coating layer interposed between the substrate and the detectable layer.

11. The security paper of claim 10, wherein the under-coating layer comprises a water-soluble resin.

12. The security paper of claim 10, wherein a thickness of the under-coating layer is in a range of about 0.1 μm to about 5 μm.

13. A composition for forming a detectable layer, the composition comprising: metal powder, an organosilicon compound, a water-soluble binder resin, and water.

14. The composition of claim 13, wherein the composition further comprises a dispersing agent.

15. A method of producing a security paper, the method comprising:
coating the composition according to claim 13 on at least a portion of at least a surface of a substrate; and
drying the coated composition.

16. The method of claim 15, wherein the substrate is used in a form of sheet or roll.

17. The method of claim 15, further comprising, prior to the coating of the composition, forming an under-coating layer on the substrate.

18. A method of producing a security paper, the method comprising:
coating the composition according to claim 14 on at least a portion of at least a surface of a substrate; and
drying the coated composition.

19. The method of claim 18, wherein the substrate is used in a form of sheet or roll.

20. The method of claim 18, further comprising, prior to the coating of the composition, forming an under-coating layer on the substrate.

21. The security paper of claim 1, wherein the substrate is in a form of sheet or roll.

22. A method of producing a security paper, the method comprising:
forming an under-coating layer on at least a portion of at least a surface of a substrate;
coating the composition on at least a portion of at least a surface of the substrate; and
drying the coated composition,
wherein the composition comprises metal powder, an organosilicon compound, a water-soluble binder resin, and water, and the substrate comprises paper or a resin film.
